(19) United States
(12) Patent Application Publication
(10) Pub. No.: US 2019/0111669 A1
(43) Pub. Date: Apr. 18, 2019

(54) FILLER-REINFORCED SOLID RESIN MULTILAYERED STRUCTURE

(71) Applicant: SABIC GLOBAL TECHNOLOGIES B.V., Bergen op Zoom (NL)

(72) Inventors: Jong-Min Choi, Gyeonggi-do (KR); Narong An, Shanghai (CN); Daejun Kim, Gyeonggi-do (KR)

(21) Appl. No.: 16/091,905

(22) PCT Filed: Apr. 6, 2017
(86) PCT No.: PCT/IB2017/000472

§ 371 Date: Oct. 5, 2018

Related U.S. Application Data
(60) Provisional application No. 62/318,984, filed on Apr. 6, 2016.
(60) Provisional application No. 62/395,469, filed on Sep. 16, 2016.

(51) Int. Cl. B32B 37/10; B32B 37/06; B32B 37/18; B32B 27/20; B32B 27/08

(52) U.S. Cl. CPC B32B 37/10; B32B 37/06; B32B 2250/24; B32B 27/20; B32B 27/08; B32B 37/18

(57) ABSTRACT

Filler-reinforced solid resin multilayered structures and methods of making the same. A method of forming a filler-re-inforced solid resin multilayered structure includes forming a layer stack including a first resin layer that is a monoextruded filler-reinforced resin layer and one or more second resin layers that are the same as or different than the first resin layer. The monoextruded filler-reinforced resin layer has a thickness of about 1 micron to less than about 1 mm. The method includes contacting the layer stack and a compression tool. The method includes compressing the layer stack with the compression tool, to laminate the layers of the layer stack and form the filler-reinforced solid resin multilayered structure.

This application claims the benefit of priority to U.S. Provisional Patent Application Ser. No. 62/318,984, filed Apr. 6, 2016, and to U.S. Provisional Patent Application Ser. No. 62/395,469, filed Sep. 16, 2016, the disclosures of which are incorporated herein in their entirety by reference.

### BACKGROUND

Although woven or non-woven mats, felts, and fabrics can be used to form reinforced resins such as glass fiber- or carbon fiber-reinforced resins having good mechanical properties, the reinforced resins are difficult and expensive to manufacture, and can have poor optical properties. The types of resins that can be used to manufacture such reinforced resins are limited because the resins must be highly flowable to wet out the structure of the reinforcing material.

### SUMMARY OF THE INVENTION

In various embodiments, the present invention provides a method of forming a filler-reinforced solid resin multilayered structure. The method includes forming a layer stack including a first resin layer that is a monoextruded filler-reinforced resin layer and one or more second resin layers that are the same as or different than the first resin layer. The monoextruded filler-reinforced resin layer includes a filler and a resin. The monoextruded filler-reinforced layer has a thickness of about 1 micron to less than about 1 mm. The second resin layer includes a resin. The method includes contacting the layer stack and a compression tool. The method includes compressing the layer stack with the compression tool, to laminate the layers of the layer stack and form the filler-reinforced solid resin multilayered structure.

In various embodiments, the present invention provides a method of forming a glass fiber-reinforced solid resin multilayered structure. The method includes forming a layer stack including at least two monoextruded glass fiber-reinforced thermoplastic resin layers. The monoextruded layers each independently have a thickness of about 1 micron to about 500 microns. The monoextruded layers independently include a thermoplastic resin and glass fibers. A refractive index of the thermoplastic resin and a refractive index of the glass fibers in each layer are within about 0.100 of one another. The method includes contacting the layer stack and a compression tool that is preheated above a glass transition temperature (T_{g}) of the thermoplastic resin in each of the monoextruded layers. The method includes compressing the layer stack with the compression tool, to laminate the layers of the layer stack and form the glass fiber-reinforced solid resin multilayered structure.

In various embodiments, the present invention provides a method of forming a filler-reinforced solid resin multilayered structure. The method includes forming a layer stack including a first resin layer that is a monoextruded filler-reinforced resin layer and one or more second resin layers that are the same as or different than the first resin layer. The monoextruded filler-reinforced resin layer includes a tiller and a resin. The monoextruded filler-reinforced layer has a thickness of about 1 micron to about 500 microns. The method includes preheating a compression tool. The method includes contacting the layer stack and a compression tool, wherein the portions of the compression tool that contact the layer stack have a roughness equal to or smoother than B3 in USA SPI standard. The method includes compressing the layer stack with the compression tool, to laminate the layers of the layer stack and form the filler-reinforced solid resin multilayered structure. The method includes cooling the compression tool. The method includes removing the filler-reinforced solid resin multilayered structure from the compression tool.

In various embodiments, the present invention provides a filler-reinforced solid resin multilayered structure. The structure includes a laminated layer stack including a cured product of a first resin layer that is a monoextruded filler-reinforced resin layer and a cured product of one or more second resin layers that are the same as or different than the first resin layer. The monoextruded filler-reinforced resin layer includes a filler and a resin. The monoextruded filler-reinforced resin layer has a thickness of about 1 micron to less than about 1 mm. About 50 wt % to about 100 wt % of the filler in the first resin layer has a longest dimension oriented within about 45 degrees of the extrusion direction of the first resin layer.

In various embodiments, the present invention provides a glass fiber-reinforced solid resin multilayered structure. The structure includes a laminated layer stack including a cured product of at least two monoextruded glass fiber-reinforced thermoplastic resin layers. The monoextruded layers each independently have a thickness of about 1 micron to about 500 microns. The monoextruded layers independently include a thermoplastic resin and glass fibers. A refractive index of the thermoplastic resin and a refractive index of the glass fibers in each layer independently is about 1.500 to about 1.600. About 50 wt % to about 100 wt % of the filler in each of the monoextruded glass fiber-reinforced thermoplastic resin layers has a longest dimension oriented within about 45 degrees of the extrusion direction of the respective resin layer.

In various embodiments, the filler-reinforced solid resin multilayered structure can have certain advantages over other filler-reinforced resins, at least some of which are unexpected. For example, in various embodiments, the filler-reinforced solid resin multilayered structure can be made using a wider variety of resins, as compared to solid resins reinforced with carbon fiber or glass fiber woven or non-woven mats, felts, and fabrics, which often require resins having high flowability to wet out the filler. In various embodiments, the filler-reinforced solid resin multilayered structure of the present invention can include a thermoplastic resin, unlike many solid resins reinforced, with carbon fiber or glass fiber woven or non-woven mats, felts, and fabrics. In various embodiments, by incorporating a thermoplastic resin, the filler-reinforced solid resin of the present invention can be more easily recyclable or reprocessable than other filler-reinforced solid resins. In various embodiments, by incorporating a thermoplastic resin, the filler-reinforced solid resin multilayered structure of the present invention can be more thermo-formable and can incorporate more thermo-formable features (e.g., ribs, gussets, hooks, and the like) than other filler-reinforced resins.

In various embodiments, the filler-reinforced solid resin multilayered structure of the present invention can have a higher proportion of the filler aligned with one another or aligned in specific directions, as compared to other filler-reinforced resins. In various embodiments, the filler-reinforced solid resin multilayered structure of the present invention can have equivalent or better mechanical properties than filler-reinforced injected molded or compression molded materials, such as higher tensile strength, higher impact strength, and a more ductile impact failure mode at a given impact energy. In various embodiments, the filler-reinforced solid resin multilayered structure can have a lower wt % loading of filler than other filler-reinforced solid resins but can have equivalent or better mechanical properties.

In various embodiments, the filler-reinforced solid resin multilayered structure of the present invention can be more transparent than other filler-reinforced solid resins. In various embodiments, color effects can be added to the filler-reinforced solid resin multilayered structure of the present invention more easily and with more vivid effects, such as due to lower loading of filler, less colorful raw materials, and better refractive index matching between filler and resin (e.g., giving higher transparency of the filler-reinforced resin), compared to other filler-reinforced, resins. In various embodiments, the filler-reinforced solid resin multilayered structure of the present invention can be less expensive, and the method of making the multilayered structure can be easier and less expensive, as compared to other filler-reinforced solids resins and methods of making the same.

### BRIEF DESCRIPTION OF THE FIGURES

The drawings illustrate generally, by way of example, but not by way of limitation, various embodiments discussed in the present document.

FIG. 1 illustrates a press, in accordance with various embodiments.

FIGS. 2A-B illustrate a press, in accordance with various embodiments.

FIGS. 3A-3E illustrate various multilayered structures, in accordance with various embodiments.

FIG. 4 illustrates a SEM image of a multilayered structure.

FIG. 5 illustrates a SEM image of a multilayered structure.

FIG. 6 illustrates a photograph of a ductile failure mode during impact testing of a structure, in accordance with various embodiments.

FIG. 7 illustrates a photograph of a brittle failure mode during impact testing of a structure, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as information that is relevant a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation. The term “UV light” as used herein refers to ultraviolet light, which is electromagnetic radiation with a wavelength of about 10 nm to about 400 nm.

The term “cure” as used herein refers to exposing to radiation in any form, heating, or allowing to undergo a physical or chemical reaction that results in hardening or an increase in viscosity. A flowable thermoplastic material can be cured by cooling it such that the material hardens. A flowable thermoset material can be cured by heating or otherwise exposing to irradiation such that the material hardens.

The term “pore” as used herein refers to a depression, slit, or hole of any size or shape in a solid object. A pore can run all the way through an object or partially through the object. A pore can intersect other pores. A pore can be produced by a pulsed laser source.

The term “groove” as used herein refers to a depression, slit, or hole having a greater length than width in a solid object. A groove can intersect other grooves. A groove can be produced by a continuous laser source.

The term “room temperature” as used herein refers to a temperature of about 15° C. to 28° C.

The term “coating” as used herein refers to a continuous or discontinuous layer of material on the coated surface, wherein the layer of material can penetrate the surface and can fill areas such as pores or grooves, wherein the layer of material can have any three-dimensional shape, including a flat or curved plane. In one example, a coating can be formed on one or more surfaces, any of which may be porous or nonporous, by immersion in a bath of coating material.

The term “surface” as used herein refers to a boundary or side of an object, wherein the boundary or side can have any perimeter shape and can have any three-dimensional shape, including flat, curved, or angular, wherein the boundary or side can be continuous or discontinuous.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted, with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂)hydrocarbylamino).

As used herein, the terms “injection molding” refers to a process for producing a molded part or form by injecting a composition including one or more polymers that are thermoplastic, thermosetting, or a combination thereof, into a mold cavity, where the composition cools and hardens to the configuration of the cavity. Injection molding can include the use of heating via sources such as steam, induction, cartridge heater, or laser treatment to heat the mold prior to injection, and the use of cooling sources such as water to cool the mold after injection, allowing faster mold cycling and higher quality molded parts or forms.

### Method of Forming a Filler-Reinforced Solid Resin Multilayered Structure.

In various embodiments, the present invention provides a method of forming a filler-reinforced solid resin multilayered structure. The method can include forming a layer stack. The layer stack can include a first resin layer that is a monoextruded filler-reinforced resin layer. The layer stack can also include one or more second resin layers that are the same as or different than the first resin layer. The monoextruded filler-reinforced resin layer includes a filler and a resin. The monoextruded filler-reinforced layer has a thickness of about 1 micron to less than about 1 mm. The second resin layer includes a resin. The method can include contacting the layer stack and a compression tool. The method can include compressing the layer stack with the compression tool, to laminate the layers of the layer stack and form the filler-reinforced solid resin multilayered structure.

The method can include forming a layer stack. The forming can occur in any suitable manner In some embodiments, forming the layer stack includes contacting together the layers of the layer stack. Forming the layer stack can include obtaining or extruding the extruded layers of the stack, such as monoextruding (e.g., extruding the layer alone with no other layer coextruded therewith) each monoextruded filler-reinforced resin layer. The forming can include obtaining, extruding, injection molding, pressing, or otherwise forming the other layers of the layer stack, such as the one or more second resin layers. For layer stacks with multiple monoextruded layers, each monoextruded layer can be independently extruded simultaneously (e.g., in separate extruders) or in series (e.g., in the same or separate extruders). In some embodiments, each layer can be made substantially simultaneously, or in series, or a combination thereof, prior to forming the layer stack.

The layer stack can include a first resin layer. The layer stack can include one first resin layer, or more than one first resin layer (e.g., 1, 2, 3, 4, 5, 6, 7, 8, 9, or 10 or more first resin layers). The first resin layer is a monoextruded filler-reinforced resin layer. The first resin layer can be cured, uncured, or a combination thereof. Each monoextruded filler-reinforced resin layer independently includes a resin and a filler; the resin in two monoextuded filler-reinforced resin layers in a layer stack can be the same or different, and the filler in two monoextruded filler-reinforced resin layers in a layer stack can be the same or different. Each monoextruded filler-reinforced resin layer (e.g., in the layer stack or in the filler-reinforced solid resin multilayered structure) can have an independently selected thickness of about 1 micron to less than about 1 mm, about 10 microns to about 500 microns, or about 1 micron or less, or less than, equal to, or greater than about 2 microns, 3, 4, 5, 6, 8, 10, 12, 14, 16, 18, 20, 25, 30, 35, 40, 45, 50, 60, 70, 80, 90, 100, 110, 120, 130, 140, 150, 160, 170, 180, 190, 200, 210, 220, 225, 230, 240, 250, 275, 300, 350, 400, 450, 500, 600, 700, 800, 900 microns, or about 1 mm or more. The monoextruded filler-reinforced resin layer can have a substantially uniform thickness throughout.

The first resin layer includes a filler. The first resin layer can include one filler or more than one filler. The one or more fillers can form any suitable proportion of the first resin layer (e.g., in a cured state, an uncured state, in the layer stack, or in the filler-reinforced solid resin multilayered structure), such as about 0.001 wt % to about 50 wt %, 5 wt % to about 40 wt % about 0.001 wt % or less, or less than, equal to, or greater than about 0.01 wt %, 0.1, 1, 2, 3, 4, 5, 6, 8, 10, 12, 14, 16, 18, 20, 22, 24, 26, 28, 30, 32, 34, 36, 38, 40, 45, or about 50 wt % or more. The filler can be homogeneously distributed in the first resin layer.

The filler can be fibrous or particulate. The filler can be glass fibers, aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, zinc oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin including various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as fillers such as mica, clay, feldspar, flue dust, fillite, quartz, quartzite, perlite, Tripoli, diatomaceous earth, carbon black, or the like, or combinations including at least one of the foregoing fillers. The filler can be coated with a layer of metallic material to facilitate conductivity, or surface treated with silanes, siloxanes, or a combination of silanes and siloxanes to improved adhesion and dispersion with the resin. The filler can be carbon fibers, glass beads, glass flakes, glass fibers, or a combination thereof. The filler can be glass fibers (e.g., soda-lime glass, fused silica glass, borosilicate glass, lead-oxide glass, aluminosilicate glass, oxide glass, glass with high zirconia content, or a combination thereof).

Glass fibers can have any suitable dimensions. The glass fibers can have a length of about 0.1 mm to about 500 mm, about 0.1 mm to about 100 mm, about 0.5 mm to about 50 mm, about 1 mm to about 5 mm, or about 0.1 mm or less, or less than, equal to, or greater than about 0.2 mm, 0.4, 0.6, 0.8, 1, 2, 3, 4, 5, 6, 8, 10, 12, 14, 16, 18, 20, 25, 30, 35, 40, 45, 50, 60, 70, 80, 90, 100, 125, 150, 175, 200, 225, 250, or about 500 mm or more.

Glass fibers can have a diameter of about 0.1 microns to about 10 mm in diameter, about 0.001 mm to about 1 mm in diameter, or about 0.1. microns or less, or less than, equal to, or greater than about 1 micron, 2, 3, 4, 5, 6, 7, 8, 9, 10, 11, 12, 13, 14, 15, 16, 17, 18, 19, 20, 22, 24, 26, 28, 30, 35, 40, 45, 50, 60, 70, 80, 90 microns, 0.1 mm, 0.2, 0.4, 0.6, 0.8, 1, 2, 3, 4, 5, 6, 7, 8, 9 mm, or about 10 mm or more.

A glass filler can have any suitable refractive index. The refractive index of the glass filler can be about 1.450 to about 1.800, or about 1.500 to about 1.600, about 1.508 to about 1.585, about 1.540 to about 1.570, or about 1.450 or less, or less than, equal to, or greater than about 1.455, 1.460, 1.465, 1.470, 1.475, 1.480, 1.485, 1.490, 1.495, 1.500, 1.505, 1.510, 1.515, 1.520, 1.525, 1.530, 1.535, 1.540, 1.545, 1.550, 1.555, 1.560, 1.565, 1.570, 1.575, 1.580, 1.585, 1.590, 1.595, 1.600, 1.605, 1.610, 1.615, 1.620, 1.625, 1.630, 1.635, 1.640, 1.645, 1.650, 1.660, 1.670, 1.680, 1.690, 1.700, 1.710, 1.720, 1.730, 1.740, 1.750, 1.760, 1.770, 1.780, 1.790, or about 1.800 or more.

The first resin layer includes a resin. The first resin layer can include one resin or more than one resin. The resin in the first resin layer can be cured, uncured, or a combination thereof. The resin in the first resin layer in the layer stack can be flowable, hardened, or in any suitable state therebetween. In some embodiments, the resin is a thermoplastic resin that is cured (e.g., has been heated during extrusion and is then cooled). In some embodiments, the resin is a thermoset resin that has been at least partially cured. During the compressing of the layer stack, the resin can be cured (e.g., for a thermoset resin, via heating during compressing; for a thermoplastic resin, via cooling and corresponding solidification that occurs after the heating). The one or more resins in the first resin layer can form any suitable proportion of the first resin layer (e.g., in the layer stack or in the filler-reinforced solid resin multilayered structure), such as about 50 wt % to about 99.999 wt % of the first resin layer, about 60 wt % to about 95 wt %, or about 50 wt % or less, or less than, equal to, or greater than about 52 wt %, 54, 56, 58, 60, 62, 64, 66, 68, 70, 72, 74, 76, 78, 80, 82, 84, 86, 88, 90, 92, 94, 96, 98, 99, 99.9, 99.99, or about 99.999 wt % or more.

The resin can be any suitable resin. The resin can be a thermoplastic resin, a thermoset resin, or any combination thereof. The resin can be an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a poly(cyclohexylenedimethylene terephthalate-co-ethylene glycol) (PCTG), a Tritan™ copolyester, a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polsulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), or a combination thereof.

The resin can be a combination of an aromatic polycarbonate and poly(1,4-cyclohexylidene cyclohexane-1,4-dicarboxylate). The aromatic polycarbonate can be any suitable aromatic polycarbonate, such as a polycarbonate derived from a hisphenol (e.g., a compound containing two hydroxyphenyl functionalities). The bisphenol can be chosen from bisphenol A (2,2-bis(4-hydroxyphenyl)propane), bisphenol AP (1,1-bis(4-hydroxyphenyl)-1-phenyl-ethane), bisphenol AF (2,2-bis(4-hydroxyphenyl)hexafluoropropane), bisphenol B (2,2-bis(4-hydroxyphenyl)butane), bisphenol BP (bis-(4-hydroxyphenyl)diphenylmethane), bisphenol C (2,2-bis(3-methyl-4-hydroxyphenyl)propane), bisphenol E (1,1-bis(4-hydroxyphenyl)ethane), bisphenol F (bis(4-hydroxydiphenyl)methane), bisphenol G (2,2-bis(4-hydroxy-3-isopropyl-phenyl)propane), bisphenol PH (5,5′-(1-methylethyliden)-bis[1,1′-(bisphenyl)-2-ol]propane), bisphenol TMC (1,1-bis(4-hydroyphenyl)-3,3,5-trimethyl-cyclohexane), bisphenol Z (1,1-bis(4-hydroxyphenyl)-cyclohexane), and combinations thereof. The bisphenol can be bisphenol A (2,2-bis(4-hydroxyphenyl)propane). The aromatic polycarbonate can be a bisphenol A-based polycarbonate (e.g., a polycarbonate derived from reaction of bisphenol A and phosgene, such as a poly(oxycarbonyloxy-1,4-phenylene(1-methylethylidene)-1,4-phenylene)). The resin can include a bisphenol A-based polycarbonate and poly(1,4-cyclohexylidene cyclohexane-1,4-dicarboxylate). The weight ratio of the aromatic polycarbonate to the poly(1,4-cyclohexylidene cyclohexane-1,4-dicarboxylate) in the resin can be any suitable weight ratio, such as about 5:95 to about 95:5, about 30:70 to about 90:10, about 70:30 to about 60:40, or about 5:95 or less, or less than, equal to, or greater than about 10:90, 15:85, 20:80, 25:75, 30:70, 35:65, 40:60, 45:55, 50:50, 55:45, 60:40, 65:35, 70:30, 75:25, 80:20, 85:15, 90:10, or about 95:5 or more. The refractive index of the aromatic polycarbonate (e.g. of a cured product thereof) can be within 0.100 of the refractive index of the poly(1,4-cyclohexylidene cyclohexane-1,4-dicarboxylate) of a cured product thereof), or the difference can be greater than, equal to, or less than about 0.100, 0.95, 0.9, 0.85, 0.8, 0.75, 0.7, 0.65, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.09, 0.08, 0.07, 0.06, 0.05, 0.04, 0.035, 0.03, 0.025, 0.02, 0.015, 0.01, 0.005, or about 0.001 or less.

The resin (e.g., the resin in a cured state) can have any suitable refractive index. In some embodiments, the resin in first resin layer (e.g. only the cured resin, not including the glass filler or other components therein) can have about the same refractive index as the resin in an uncured state. In other embodiments, the refractive index of the resin can change upon curing. The refractive index of the resin can be about 1.450 to about 1.800, or about 1.500 to about 1.600, about 1.508 to about 1.585, about 1.540 to about 1.570, or about 1.450 or less, or less than, equal to, or greater than about 1.455, 1.460, 1.465, 1.470, 1.475, 1.480, 1.485, 1.490, 1.495, 1.500, 1.505, 1.510, 1.515, 1.520, 1.525, 1.530, 1.535, 1.540, 1.545, 1.550, 1.555, 1.560, 1.565, 1.570, 1.575, 1.580, 1.585, 1.590, 1.595, 1.600, 1.605, 1.610, 1.615, 1.620, 1.625, 1.630, 1.635, 1.640, 1.645, 1.650, 1.660, 1.670, 1.680, 1.690, 1.700, 1.710, 1.720, 1.730, 1.740, 1.750, 1.760, 1.770, 1.780, 1.790, or about 1.800 or more.

Monoextruding the first resin layer (e.g., extruding the layer alone as a thin layer with no other layer coextruded therewith) can generate shear within the first resin layer that can orient filler therein having a longest dimension, such as fibrous filler, such as glass fibers, in the extrusion direction of the monoextruded layer. For fibers that are not straight, the orientation of the fiber can be considered the average orientation of the fiber. The orientation of filler in the extrusion direction resulting from monoextruding a thin layer can be greater than any orientation of filler that can occur from extruding a thick layer, or that can occur from coextruding several layers together. The alignment of the filler in the first resin layer in the extrusion direction can result in advantageous mechanical properties of the resulting filler-reinforced solid resin multilayered structure, such as greater tensile strength or impact strength for a given loading of filler, and a more ductile impact mode at a given impact energy. For a filler-reinforced solid resin multilayered structure that contains multiple monoextruded first resin layers, the monoextruded first resin layers can be arranged in the multilayered structure such that the extrusion direction of the layers are parallel to one another, perpendicular to one another, or any angle therebetween (e.g., less than, equal to, or greater than 10 degrees, 20, 30, 40, 50, 60, 70, 80, or about 90 degrees). About 50 wt % is to about 100 wt % is of the filler in the first resin layer can have a longest dimension oriented within about 45 degrees of the extrusion direction of the first resin layer (e.g., or within less than, equal to, or greater than about 40 degrees, 35, 30, 25, 20, 15, 10, 5, or about 0 degrees), or about 90 wt % to about 100 wt % of the filler, or about 50 wt % or less, or less than, equal to, or greater than about 52, 54, 56, 58.60, 62, 64, 66, 68, 70, 72, 74, 76.78, 80, 82, 84, 86, 88, 90, 91.92, 93, 94, 95, 96, 97, 98, 99, 99.9, or about 99.999 wt % or more.

The layer stack can also include one or more second resin layers (e.g., 1, 2, 3, 4, 5, 6, 7, 8, 9, or 10 or more) that are the same as or different than the first resin layer. The layer stack can include one second resin layer. The layer stack can include more than one second resin layer. The second resin layer includes a resin. The second resin layer can be a first resin layer, such that the second resin layer is a monoextruded filler-reinforced resin layer that includes a resin (e.g., any resin described herein as suitable for the first resin layer) and a filler (e.g., any resin described herein as suitable for the first resin layer). The second resin layer can be the same as the first resin layer, such that the resin and the filler in the second resin layer are the same as the resin and the filler in the first resin layer. In some embodiments, the second resin layer can be free of filler, or can include a different one or more fillers than the first resin layer, such as any one or more fillers described herein as suitable for the first resin layer in any wt % described as suitable for the first resin layer. The second resin layer can include any suitable one or mare resins, such as any one or more resins describe herein as suitable for the first resin layer in any wt % described as suitable for the first resin layer.

The second resin layer can be formed in any suitable way. The second resin layer can be extruded (e.g., monoextruded or coextruded with another layer). The second resin layer can be injection molded, laminated, hot formed, or pressed (e.g., any suitable method that can apply heat and pressure, such as belt pressed or hot roll pressed). In some embodiments, the second resin layer can be more than one layer that have been laminated or otherwise fused together; in some embodiments, the second resin layer originates from a single layer.

In some embodiments, the first resin layer (e.g., at least one first layer, in embodiments having multiple first resin layers) can be adjacent to (e.g., filly contacting on one side thereof) the second layer (e.g., at least one second layer, in embodiments having multiple second resin layers). In some embodiments, the first layer (e.g., at least one first layer, in embodiments, having multiple first resin layers) can be separated from the second layer (e.g., at least one second layer, in embodiments having multiple second resin layers) by at one or more layers e.g., the first layer and the second layer can sandwich the one or more separating layers).

The second resin layer can have any suitable thickness. The second resin layer can have a substantially uniform thickness throughout. The second layer can have a thickness of about 1 micron to about 100 mm, about 10 microns to about 10 mm, or about 1 micron or less, or less than, equal to, or greater than about 2 microns, 3, 4, 5, 6, 7, 8, 9, 10, 12, 14, 16, 18, 20, 25, 30, 35, 40, 45, 50, 55, 60, 65, 70, 75, 80, 85, 90, 95, 100, 105, 110, 115, 120, 125, 130, 135, 140, 145, 150, 160, 170, 180, 190, 200, 210, 220, 225, 230, 240, 250, 275, 275, 300, 350, 400, 450, 500, 600, 700, 800, 900 microns, 1 mm, 1.5, 2, 2.5, 3, 4, 5, 6, 7, 8, 9, 10, 15, 20, 25, 30, 40, 50, 75, or about 100 mm or more.

The resin in the second resin layer can have any suitable refractive index (e.g., the resin in the second resin layer in a cured state, not including any fillers therein), such as about 1.450 to about 1.800, or about 1.500 to about 1.600, about 1.508 to about 1.585, about 1.540 to about 1.570, or about 1.450 or less, or less than, equal to, or greater than about 1.455, 1.460, 1.465, 1.470, 1.475, 1.480, 1.485, 1.490, 1.495, 1.500, 1.505, 1.510, 1.515, 1.520, 1.525, 1.530, 1.535, 1.540, 1.545, 1.550, 1.555, 1.560, 1.565, 1.570, 1.575, 1.580, 1.585, 1.590, 1.595, 1.600, 1.605, 1.610, 1.615, 1.620, 1.625, 1.630, 1.635, 1.640, 1.645, 1.650, 1.660, 1.670, 1.680, 1.690, 1.700, 1.710, 1.720, 1.730, 1.740, 1.750, 1.760, 1.770, 1.780, 1.790, or about 1.800 or more.

The resin in the second resin layer, the resin in the first resin layer, the filler in the first resin layer, and any filler in the second resin layer, can be selected such that the refractive index of the components have a difference that is greater than, equal to, or less than about 0.100, 0.95, 0.9, 0.85, 0.8, 0.75, 0.7, 0.65, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.09, 0.08, 0.07, 0.06, 0.05, 0.04, 0.035, 0.03, 0.025, 0.02, 0.015, 0.01, 0.005, or about 0.001 or less. By closely matching the refractive index, the resulting filler-reinforced solid resin multilayered structure can have a high degree of optical clarity, such as high transmittance and low haze. Any two or more of the resin in the first resin layer, the filler in the, first resin layer, the resin in the second resin layer, and filler in the second layer (if present) can have refractive indexes that have a difference therebetween of greater than, equal to, or less than about 0.100, 0.95, 0.9, 0.85, 0.8, 0.75, 0.7, 0.65, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.09, 0.08, 0.07, 0.06, 0.05, 0.04, 0.035, 0.03, 0.025, 0.02, 0.015, 0.01, 0.005, or about 0.001 or less.

The method can include contacting the layer stack and a compression tool. The compression tool can be any suitable compression tool, such as a roller or a press. The compression tool can be a vertical or horizontal press. The compression tool can be a roll press or a double belt press. The method can include compressing the layer stack with the compression tool (e.g., pressing from the top and bottom of the stack) to laminate the layers of the layer stack and form the filler-reinforced solid resin multilayered structure. The compressing of the layer stack can include heating the layer stack, such as to melt thermoplastic resins in the layer stack (e.g., which can be cured by cooling and solidifying) or to cure thermoset resins in the layer stack. The compressing can include adequate pressure such that substantially no air bubbles or gaps occur between layers, and such that the layers are in intimate contact. The compressing can occur for any suitable amount of time, such as about 0.1 s to about 10 h, about 1 s to about 5 h, or about 5 s to about 1 min, or about 0.1 s or less, or about 0.5 s, 1, 2, 3, 4, 5, 10, 20, 30, 45 s, 1 min, 2, 3, 4, 5, 10, 15, 20, 30, 45 min, 1 h, 2, 3, 4, or about 5 h or more.

The method can include heating the compression tool. The heating can be performed in any suitable way, such as by induction heating, cartridge heating, conductive film heating, by passing a heated material through conduits in the compression tool (e.g., hot air heating, hot water heating, steam heating, compressed hot water heating, oil heating), or a combination thereof. The heating can be performed prior to contacting the compression tool and the layer stack, such that the compression tool is preheated to a preheat temperature at the time of contacting of the compression tool and the layer stack. The heating can be performed before the compressing of the layer stack, during the compressing of the layer stack, after the compressing of the layer stack, or a combination thereof. The heating can be performed to any suitable temperature, such that the method can be performed as described herein, such as at or above the melting point of one or more resins in the layer stack, at or above the glass transition temperature of one or more resins in the layer stack, at or above the heat deflection temperature of one or more resins in the layer stack, or any combination thereof.

At the time of insertion in the compression tool, the layer stack can have any suitable temperature. In some embodiments, the layer stack can have a temperature near room temperature. In some embodiments, the layer stack can be preheated at the time of insertion into the compression toot, such as to a temperature at or below the melting paint of one or more resins in the layer stack, at or below the glass transition temperature of one or more resins in the layer stack, at or below the heat deflection temperature of one or more resins in the layer stack, or any combination thereof.

The method can include curing the resin the first and second layers to the form the filler-reinforced solid resin multilayered structure. For thermoplastic resins, curing can include allowing the thermoplastic resin to cool to the point of solidification, which can occur during the compressing or after the compressing. For thermoset resins, curing can include heating or otherwise irradiating the thermoset resin to induce crosslinking or other chemical reactions to provide a solidified and cured thermoset resin. For a layer stack including both thermoset and thermoplastic resins, curing can include both of the curing mechanisms described in this paragraph.

The method can include cooling the compression tool during or after the compressing and before removing the filler-reinforced solid resin multilayered structure from the compression tool. The cooling can be performed in any suitable manner, such as by passing a cooling fluid through conduits in the compression tool. The cooling can be to any suitable temperature, such as to below the solidification temperature of a thermoplastic resin in the layer stack, or to any other suitable temperature.

The portions of the compression tool that contact the layer stack during the compressing can have a minimal degree of smoothness to impart smoothness to the resulting filler-reinforced solid resin multilayered structure, which can result in improved optical properties (e.g., high transmittance, lower haze). The portions of the compression tool that contact the layer stack during the compressing can have any suitable degree of roughness with the surface that contacts the layer stack during the compressing being free of surface roughness higher than the maximum surface roughness specified), such as equal to or smoother than B3 in USA SPI standard, equal to or smoother than A3 in USA SPI standard, or less smooth than, equally smooth to, or more smooth than about B2, B1, A3, A2, or about A1 or more. The portions of the compression tool that contact the layer stack can have a surface roughness of about 2 microns or less, about 1 nm to about 50 micron, about 1 nm to about 10 microns, about 0.1 am to about 50 nm, about 1 nm to about 10 nm, or greater than, equal to, or less than about 50 microns, 40, 30, 20, 18, 16, 14, 12, 10, 9, 8, 7, 6, 5, 4, 3, 2, 1, 0.9, 0.8, 0.7, 0.6, 0.5, 0.4, 0.3, 0.2 microns, 100 nm, 90 am, 80, 70, 60, 50, 40, 35, 30, 25, 20, 18, 16, 15, 14, 13, 12, 11, 10, 9, 8, 7, 6, 5, 4, 3, 2, 1, 0.5 nm, or about 0.1 nm or less. The portions of the compression tool that contact the layer stack can have a surface roughness VDI 3400 of about 26 or less, such as less then, equal to, or greater than about 25, 24, 23, 22, 21, 20, 19, 18, 17, 16, 15, 14, 13, 12, 11, 10, 9, 8, 7, 6, 5, 4, 3, 2, 1, 0, 0.1, 0.01, or about 0.001 or less,

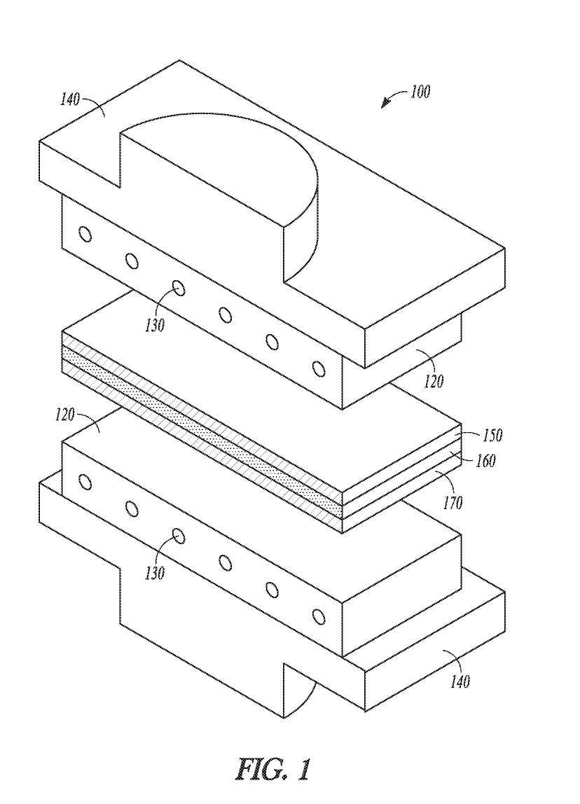

FIG. 1 illustrates an embodiment of a press 100 and method of using the same to form a filler-reinforced solid resin multilayered structure. The layer stack can include second resin layers 150 and 170 and first resin layer 160 sandwiched therebetween. Layers 150, 160, and 170 include a thermoplastic resin. Monoextruded layer 160 includes a glass fiber filler therein. The press 100 can be preheated above T_{g} of the thermoplastic resins in the layer stack, 150, 160, and 170, by passing a heating fluid through the conduits 130 in each half 120 of the press 100. The surfaces 140 of the press 100 that contact the layer stack, 150, 160, and 170, can be smooth to impart smoothness to the exterior of the formed filler-reinforced solid resin multilayered structure. The preheated press 100 can compress the layer stack, 150, 160, and 170. During the compressing, the press 100 can be cooled to near room temperature by passing a cooling fluid through the conduits 130 in each half 120 of the press 100. The compressing and cooling forms a filler-reinforced solid resin multilayered structure (not shown).

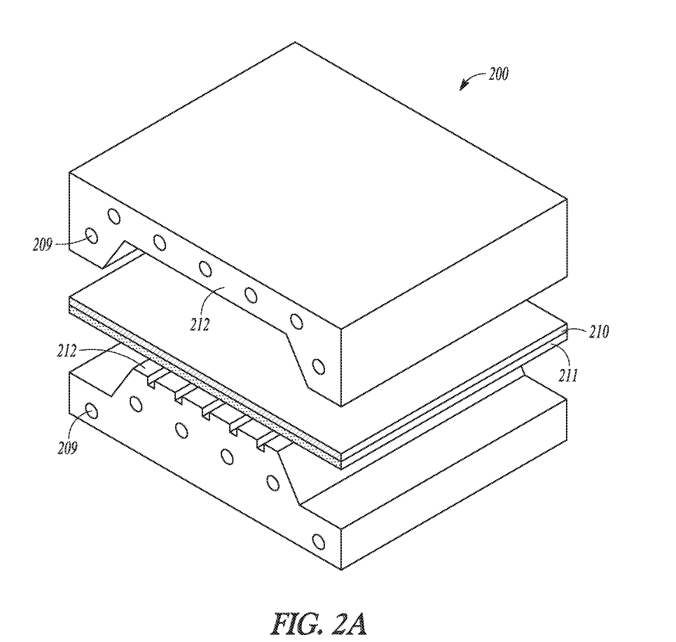

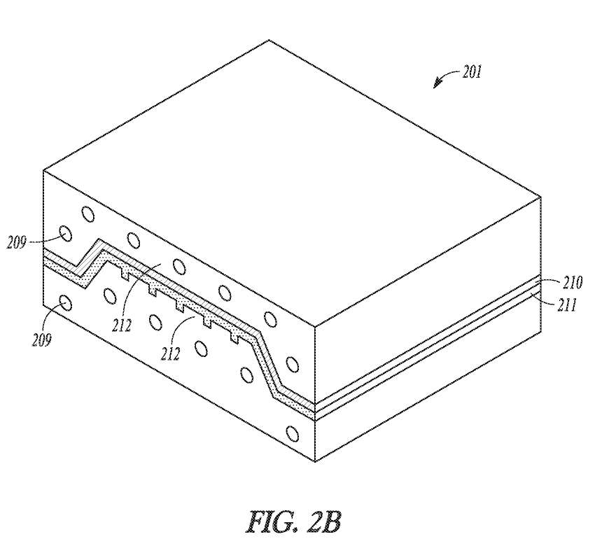

FIGS. 2A-B illustrate an embodiment of a press, in accordance with various embodiments. FIGS. 2A-B illustrate an embodiment of a press in an uncompressed state 200 and a compressed state 201 and method of using the same to form a filler-reinforced solid resin multilayered structure. The layer stack can include second resin layer 210 and first resin layer 211. Layers 210 and 211 include a thermoplastic resin. Monoextruded layer 211 includes a glass fiber tiller therein. The press 200 can be preheated above T_{g} of the thermoplastic resins in the layer stack, 210 and 211, by passing a heating fluid through the conduits 209 in each half of the press 200. The surfaces 212 of the press 200 that contact the layer stack, 210 and 211, can be smooth to impart smoothness to the exterior of the formed filler-reinforced solid resin multilayered structure. The surfaces 212 of the press 200 that contact the layer stack, 210 and 211, include a shape and surface features (ribs) to be imparted to the layer stack and to the resulting filler-reinforced solid resin multilayered structure. The preheated press 200 can compress the layer stack, 210 and 211, as shown in FIG. 2B. During the compressing, the press 201 can be cooled to near room temperature by passing a cooling fluid through the conduits 209 in each half of the press 201. The compressing and cooling forms a filler-reinforced solid resin multilayered structure (not shown) having the shape of layer stack 210 and 211 shown in FIG. 2B.

The layer stack can include any suitable arrangement of layers. The layer stack can include first resin layers and second resin layers in alternating or repeating arrangements. For example, the layer stack can include layer (a1), the first resin layer. The layer stack can further include layer (b1), the second resin layer, wherein layer (a1) is fully in contact with layer (b). In some embodiments, layer (a1) and layer (b1) are the only layers of the layer stack, or any other suitable one or more layers can be included. Layer (b1) can be the same or different than layer (a1). In some embodiments, layer (b1) can be a first resin layer. When two layers are fully in contact with one another, substantially all of one major side of one layer is contacting substantially all of one major side of the other layer.

In some embodiments, the layer stack (e.g., layer (a1) and (b1)) can further include layer (a2), another first resin layer that is the same or different than layer (a1), wherein layer (a2) is fully in contact with layer (b1), such that layers (a1) and (a2) sandwich (b1). In some embodiments, layers (a1), (a2), and (b1) are the only layers of the layer stack, or any other suitable one or more layers can be included. In some embodiments, multiple (a1) or (a2) layers are included in the layer stack.

In some embodiments, the layer stack (e.g., layer (a1) and (b1)) can further include layer (b2), another second resin layer that is the same or different than layer (b2), wherein layer (b2) is fully in contact with layer (a1), such that layers (b1) and (b2) sandwich layer (a1). In some embodiments, layers (a1), (b1), and (b2) are the only layers of the layer stack, or any other suitable one or more layers can be included. In some embodiments, multiple (b1) or (b2) layers can be included in the layer stack.

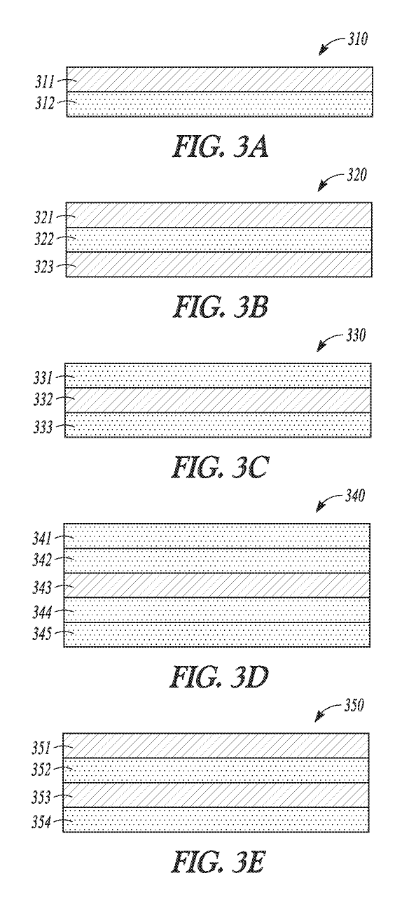

FIGS. 3A-3E illustrate various multilayered structures, in accordance with various embodiments. Layer stack 310 includes second resin layer 311 and first resin layer 312, wherein layers 311 and 312 are fully in contact with one another. Layer stack 320 includes second resin layer 321, first resin layer 322, and second resin layer 323, wherein layer 321 is fully in contact with layer 322 and layer 322 is fully in contact with layer 323. Layer stack 330 includes first resin layer 331, second resin layer 332, and first resin layer 333, wherein layer 331 is fully in contact with layer 332, and layer 332 is fully in contact with layer 331 Layer stack 340 includes first resin layer 341, first resin layer 342, second resin layer 343, first resin layer 344, and first resin layer 345, wherein layer 341 is fully in contact with layer 342, layer 342 is fully in contact with layer 343, layer 343 is fully in contact with layer 344, and layer 344 is fully in contact with layer 345. Layer stack 350 includes second resin layer 351, first resin layer 352, second resin layer 353, first resin layer 354, wherein layer 351 is fully in contact with layer 352, layer 352 is fully in contact with layer 353, and layer 353 is fully in contact with layer 354.

### Glass Fiber-Reinforced Solid Resin Multilayered Structure.

In various embodiments, the present invention provides a filler-reinforced solid resin multilayered structure. The filler-reinforced solid resin multilayered structure can be any suitable filler-reinforced solid resin multilayered structure that can be made using an embodiment of the method described herein. The filler-reinforced solid resin multilayered structure can include a laminated layer stack. The laminated layer stack can include a cured product of a first resin layer that is a monoextruded filler-reinforced resin layer. The laminated layer stack can include a cured product of one or more second resin layers that are the same as or different than the first resin layer. The monoextruded filler-reinforced resin layer can include a filler and a resin. The monoextruded filler-reinforced resin layer can have a thickness of about 1 micron to less than about 1 mm. About 50 wt % to about 100 wt % of the filler in the first resin layer can have a longest dimension oriented within about 45 degrees of the extrusion direction of the first resin layer.

The filler in the first resin layer can be any suitable filler, such as glass fibers. The resin in the first resin layer can be any suitable resin, such as including an aromatic polycarbonate and poly(1,4-cyclohexylidene cyclohexane-1,4-dicarboxylate). The refractive index of the glass fibers and the resin in the first resin layer can be independently about 1.500 to about 1.600.

The first resin layer can be in contact with the second resin layer. The layer stack can include more than one first resin layer. For example, the cured product of the second layer can be the same as the cured product of the first layer.

The filler-reinforced solid resin multilayered structure can have any suitable properties consistent with the embodiments of the method for making the filler-reinforced solid resin multilayered structure described herein. For example, the filler-reinforced solid resin multilayered structure can have any suitable transmittance (indicating total transmittance herein unless otherwise indicated, the total amount of transmitted light including both collimated transmittance and scattered transmittance), such as a transmittance at 380-780 nm at 2.25 min thickness of about 60% to about 95%, about 80% to about 90%, or about 60% or less, or less than, equal to, or greater than about 62%, 64, 66, 68, 70, 72, 74, 76, 78, 80, 82, 84, 86, 88, 90, 92, 94%, or about 95% or more. In some embodiments, the filler-reinforced solid resin multi layered structure can have a transmittance at 380-780 nm at 250 microns thickness of about 60% to about 100%, or about 80% to about 99.5%, or about 60% or less, or less than, equal to, or greater than about 62%, 64, 66, 68, 70, 72, 74, 76, 78, 80, 82, 84, 86, 88, 90, 91, 92, 93, 94, 95, 96, 97, 98, 99, 99.5, or about 99.9% or more.

The filler-reinforced solid resin multilayered structure can have any suitable haze, such as a haze at 380-780 nm at 2.25 mm thickness of about 0.2% to about 20%, about 1% to about 10%, or about 0.2% or less, or less than, equal to, or greater than about 0.3%, 0.4, 0.5, 0.6, 0.8, 1, 1.2, 1.4, 1.6, 1.8, 2, 2.5, 3, 3.5, 4, 4.5, 5, 6, 7, 8, 9, 10, 11, 12, 13, 14 15, 16, 17, 18, 19%, or about 20% or more. The multilayered structure can have a haze at 380-780 nm at 250 microns thickness of about 0.2% to about 20%, or about 1% to about 5%, or less than, equal to, or greater than about 0.3%, 0.4, 0.5, 0.6, 0.8, 1, 1.2, 1.4, 1.6, 1.8, 2, 2.5, 3, 3.5, 4, 4.5, 5, 6, 7, 8, 9, 10, 11, 12, 13, 14, 15, 16, 17, 18, 19%, or about 20% or more.

The filler-reinforced solid resin multilayered structure can have any suitable hardness, such as a hardness of about 2B to about 9H, or about F to about 3H, or about 2B, or less hard than, equal to, or softer than about B, HB, F, H, 2H, 3H, 4H, 5H, 6H, 7H, 8H, or about 9H or harder.

The surface of the filler-reinforced solid resin multilayered structure can have any suitable degree of roughness (e.g., with the surface being free of surface roughness higher than the maximum surface roughness specified), such as equal to or smoother than B3 in USA SPI standard, equal to or smoother than A3 in USA SPI standard, or less smooth than, equally smooth to, or more polished than about B2, B1, A3, A2, or about A1 or more. The filler-reinforced solid resin multilayered structure can have a surface roughness of about 2 microns or less, about 1 nm to about 50 micron, about 1 nm to about 10 microns, about 0.1 nm to about 50 nm, about 1 nm to about 10 nm, or greater than, equal to, or less than about 50 microns, 40, 30, 20, 18, 16, 14, 12, 10, 9, 8, 7 6, 5, 4, 3, 2, 1, 0.9, 0.8, 0.7, 0.6, 0.5, 0.4, 0.3, 0.2 microns, 100 nm, 90 nm, 80, 70, 60, 50, 40, 35, 30, 25, 20, 18, 16, 1.5, 14, 13, 12, 11, 10, 9, 8, 7, 6, 5, 4, 3, 2, 1, 0.5 nm, or about 0.1 nm or less. The filler-reinforced solid resin multilayered structure can have a surface roughness VDI 3400 of about 26 or less, such as less then, equal to, or greater than about 25, 24, 23, 22, 21, 20, 19, 18, 17, 16, 15, 14, 13, 12, 11, 10, 9, 8, 7, 6, 5, 4, 3, 2, 1, 0, 0.1, 0.01, or about 0.001 or less. The filler-reinforced solid resin multilayered structure can have any kind of texture for decoration or other effects.

### EXAMPLES

Various embodiments of the present invention can be better understood by reference to the following Examples which are offered by way of illustration. The present invention is not limited to the Examples given herein.

The extruded glass fiber-filled film used was an extruded 65:35 by weight mixture of bisphenol-A based polycarbonate having a refractive index of 1.586 and poly(1,4-cyclohexylidene cyclohexane-1,4-dicarboxylate) having a refractive index of 1.510, which included 20 wt % chopped glass fibers from Nippon Electric Glass Co., Ltd., (NEG) that were about 3 mm in length and about 13 microns in diameter, having a refractive index of 1.567. The extruded glass fiber filled film had a thickness of 125 microns or 250 microns, and had a refractive index of about 1.55 to about 1.57.

The pressed glass fiber-free film used was SABIC Xylex™ X7509HP, having a thickness of 2 mm, which had a refractive index of about 1.55 to about 1.57, was formed by preheating a tool to 70° C., placing the film in the tool and heating the tool to 160° C., then pressing in the tool at 160° C. for 5 seconds, and then cooling by injecting 40° C. water into cooling channels in the press.

The press used herein had polished surfaces that contacted and pressed the layer stack on the level of A3 smoothness under the USA SPI (society of plastic industry) standard. The press used herein was preheated to the designated temperature before being contacted to the uncured layer stack. For example, the

The transmittance measured was total transmittance. The transmittance and haze were measured by a Haze Gard from BYK-Gardner with illuminant CIE-C using a Halogen D65 (CIE standard) light source at 380 nm to 780 nm.

The flexural modulus and increment rate were measured using a 3-point flexural test with Universal Test machine from MTS Systems Corporation, using a speed of 10 mm/s and a specimen of 30 mm width, 2 mm thickness, and a span of 50 mm.

Dynatup impact testing was performed using a Dynatup® machine from Instron®, with 30 cm height and 4.78 kg tub loading.

Pencil hardness was measured using ASTM D3363, using 1 kg load. The hardness test included five repeated measurements by the pencil hardness test procedure, with the pencil hardness being the hardness of the pencil used for the test when none of the measurements result in scratches or other disturbances to the appearance. For example, if a 3H pencil is used for five test procedures and no appearance disturbances occur, then the pencil hardness of the material is at least 3H. Pencil hardness is measured on the scale of 9B (softest), 8B, 7B, 6B, 5B, 4B, 3B, 2B, B, HB, F, H, 2H, 3H, 4H, 5H, 6H, 7H, 8H, 9H (hardest).

### Example 1

### Interface Quality

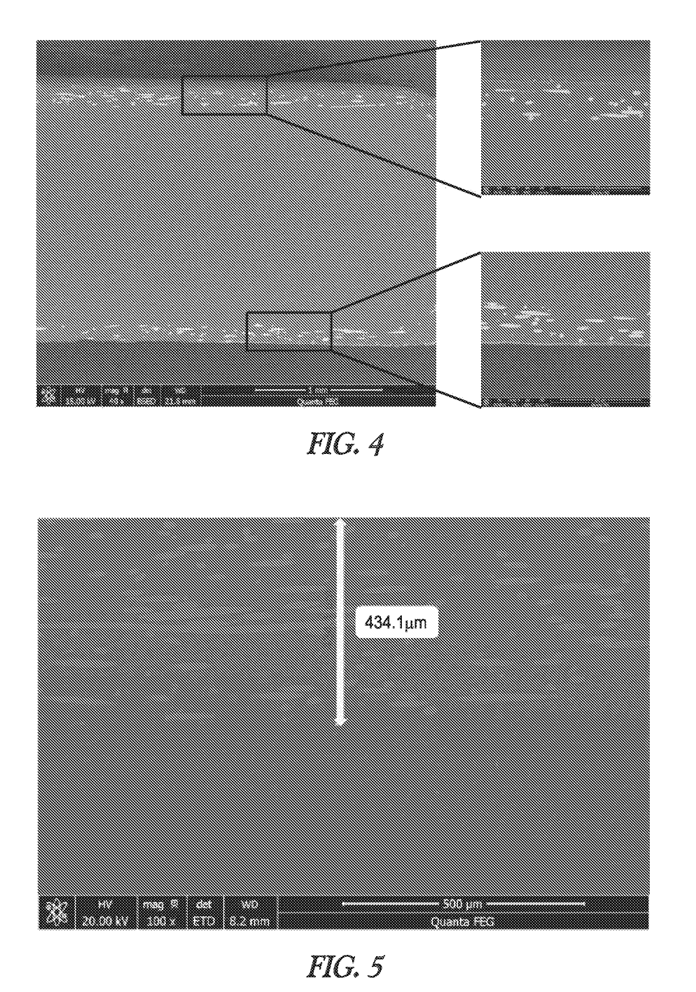

Two extruded 120 micron-thick glass fiber-filled films were placed on the top and bottom of a pressed glass fiber-free film such that the extrusion direction of each extruded film was in parallel. The press was preheated to 160° C. The stack was pressed from the top and bottom sides using the press at 160° C. for 5 seconds, followed by cooling by injecting 40° C. water into cooling channels in the press. FIG. 4 illustrates a scanning electron microscope (SEM) image of the laminated structure formed. No interface was visible between the layers of the laminated structure formed.

Three extruded 120 micron-thick glass fiber-filled films were placed together such that the extrusion direction of each extruded film was in parallel. The press was preheated to 160° C. The stack was pressed from the top and bottom sides using the press at 160° C. for 5 seconds, followed by cooling by injecting 40° C. water into cooling channels in the press. FIG. 5 illustrates a SEM image of the laminated structure formed. No interface was visible between the layers of the laminated structure formed.

The lack of a visible interface between the layers indicated strong adhesion between the layers and no void issues.

### Example 2A

### Optical Quality and Flexural Modulus

On top on a pressed glass fiber-free film was laid 0, 1, 2, or 3 layers of extruded 120 micron-thick glass fiber-filled film such that the extrusion direction of each extruded film was in parallel. The press was preheated to 160° C. The stacks were pressed from the top and bottom sides using the press at 160° C. for 5 seconds, followed by cooling by injecting 40° C. water into cooling channels in the press. The transmittance and haze of the resulting structures were measured and are given in Table 1.

TABLE 1

| # of layers of glass | Transmittance | Haze |
|---|---|---|
| fiber filled film | [%] | [%] |
| 0 | 87.70 | 0.50 |
| 1 | 86.65 | 1.59 |
| 2 | 85.85 | 3.46 |
| 3 | 85.00 | 6.61 |

The flexural modulus and increment rate of the structures were measured and are given in Table 2.

TABLE 2

| # of Layer of | | |
|---|---|---|
| Chopped Glass-Fiber | Modulus | Increment Rate |
| 20% filled film | [GPa] | [%] |
| 0 | 1.20 | 100 |
| 1 | 2.90 | 242 |
| 2 | 4.10 | 342 |
| 3 | 4.70 | 392 |

### Example 2B

### Optical Quality, Flexural Modulus, and Impact Strength

On top on a pressed glass fiber-free film was laid 0 or 1 layer of extruded 120 micron- or 250 micron-thick glass fiber-filled film. The press was preheated to 160° C. The stacks were pressed from the top and bottom sides using the press at 160° C. for 5 seconds, followed by cooling by injecting 40° C. water into cooling channels in the press. The transmittance and haze of the resulting laminated structures were measured and are given in Table 3.

TABLE 3

| Thickness of layers of | | |
|---|---|---|
| glass fiber filled film | Transmittance | Haze |
| [microns] | [%] | [%] |
| 0 | 87.70 | 0.50 |
| 120 | 86.65 | 1.59 |
| 250 | 86.00 | 3.61 |

The flexural modulus and increment rate of the structures were measured and are given in Table 4.

TABLE 4

| Chopped Glass-Fiber | | |
|---|---|---|
| 20% filled film thickness | Modulus | Increment Rate |
| [micrometer] | [GPa] | [%] |
| 0 | 1.20 | 100 |
| 120 | 2.90 | 242 |
| 250 | 3.66 | 305 |

The impact energy and retention rate of the structures were measured using a Dynatup impact test and are given in Table 5, with a 2 mm-thick injection molded film formed from Sample 2B, measured as a comparative sample, which was a 65:35 by weight mixture of bisphenol-A based polycarbonate having a refractive index of 1.586 and poly(1,4-cyclohexylidene cyclohexane-1,4-dicarboxylate) having a refractive index of 1.510, which included 20 wt % chopped glass fibers from Nippon Electric Glass Co., Ltd., (NEG) that were about 3 mm in length and about 13 microns in diameter, having a refractive index of 1.567.

TABLE 5

| | Chopped Glass-Fiber | Impact | Retention |
|---|---|---|---|
| | 20% filled film thickness | Energy | Rate |
| Substrate | [micrometer] | [J] | [%] |
| Xylex ™ X7509HP | 0 | 67.69 | 100 |
| Xylex ™ X7509HP | 120 | 43.36 | 64 |
| Xylex ™ X7509HP | 250 | 49.39 | 73 |

| | | |
|---|---|---|
| Injection molded Sample 2B | 22.12 | 33 |

FIG. 6 illustrates a photograph of the ductile failure mode observed in the Dynatup impact testing of the Sample including the 120 micron Xylex™ X7509HP layer.

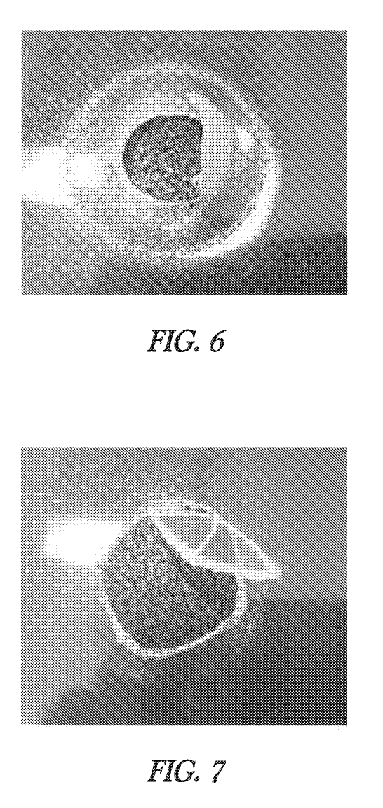

FIG. 7 illustrates a photograph of the brittle failure mode observed in the Dynatup impact testing of the injection molded Sample 2B.

### Example 3

### Surface Hardness

On top on a pressed glass fiber-free film was laid 0 or 1 layer of extruded 120 micron-thick glass fiber-filled film. The press was preheated to 160° C. The stacks were pressed from the top and bottom sides using the press at 160° C. for 5 seconds, followed by cooling by injecting 40° C. water into cooling channels in the press. A 2 mm-thick injection molded film formed from Sample 3, which was a polycarbonate and polyester blend that included 15 wt % chopped glass fibers, was used as a comparative sample. The pencil hardness of the resulting structures was measured and is given in Table 6.

TABLE 6

| Specimen | Pencil Hardness |
|---|---|
| Xylex ™ X7509HP | 2B |
| Xylex ™ X7509HP + Chopped | H |
| GF 20% | |
| Sample 3, injection molded | 2H |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments.

The following exemplary embodiments are provided, the numbering of which is not to be construed as designating levels of importance:

Embodiment 1 provides a method of forming a filler-reinforced solid resin multilayered structure, the method comprising:

forming a layer stack comprising a first resin layer that is a monoextruded filler-reinforced resin layer and one or more second resin layers that are the same as or different than the first resin layer, the monoextruded filler-reinforced resin layer comprising a filler and a resin and having a thickness of about 1 micron to less than about 1 mm, the second resin layer comprising a resin;

contacting the layer stack and a compression tool; and

compressing the layer stack with the compression tool, to laminate the layers of the layer stack and form the filler-reinforced solid resin multilayered structure.

Embodiment 2 provides the method of Embodiment 1, wherein the first resin layer has a thickness of about 1 micron to less than about 1 mm.

Embodiment 3 provides the method of any one of Embodiments 1-2, wherein the first resin layer has a thickness of about 10 microns to about 500 microns.

Embodiment 4 provides the method of any one of Embodiments 1-3, wherein the filler in the first resin layer is about 0.001 wt % to about 50 wt % of the first resin layer.

Embodiment 5 provides the method of any one of Embodiments 1-4, wherein the filler in the first resin layer is about 5 wt % to about 40 wt % of the first resin layer.

Embodiment 6 provides the method of any one of Embodiments 1-5, wherein the filler in the first resin layer comprises carbon fibers, glass beads, glass flakes, glass fibers, or a combination thereof.

Embodiment 7 provides the method of any one of Embodiments 1-6, wherein the fitter in the first resin layer comprises glass fibers.

Embodiment 8 provides the method of any one of Embodiments 1-7, wherein the filler in the first resin layer comprises glass, wherein the filler has a refractive index of about 1.450 to about 1.800.

Embodiment 9 provides the method of Embodiment therein the filler in the first resin layer has a refractive index of about 1.500 to about 1.600.

Embodiment 10 provides the method of any one of Embodiments 1-9, wherein the resin in the first resin layer is about 50 wt % to about 99.999 wt % of the first resin layer.

Embodiment 11 provides the method of any one of Embodiments 1-10, wherein the resin in the first resin layer is about 60 wt % to about 95 wt % of the first resin layer.

Embodiment 12 provides the method of any one of Embodiments 1-11, wherein the resin in the first resin layer is a thermoplastic resin.

Embodiment 13 provides the method of any one of Embodiments 1-12, wherein the resin in the first resin layer comprises an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer CP), a polyacetal polymer (POM or acetal), a polyacrylate polymer, a polymethylmethacryiate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a poly(cyclohexylenedimethylene terephthalate-co-ethylene glycol) (PCTG), a Tritan™ copolyester, a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSV), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAT), a polyarylate polymer, a polyoxymethylene polymer (POM), a styrene-acrylonitrile polymer (SAN), or a combination thereof.

Embodiment 14 provides the method of any one of Embodiments 1-13, wherein the resin in the first resin layer comprises an aromatic polycarbonate and poly(1,4-cyclohexylidene cyclohexane-1,4-dicarboxylate).

Embodiment 15 provides the method of Embodiment 14, wherein the resin in the first resin layer has a weight ratio of the aromatic polycarbonate to the poly(1,4-cyclohexylidene cyclohexane-1,4-dicarboxylate) of about 70:30 to about 60:40.

Embodiment 16 provides the method of any one of Embodiments 1-15, wherein the resin in the first resin layer comprises a bisphenol A-based polycarbonate and poly(1,4-cyclohexylidene cyclohexane-1,4-dicarboxylate).

Embodiment 17 provides the method of any one of Embodiments 1-16, wherein the resin in the first resin layer has a refractive index of about 1.450 to about 1.800.

Embodiment 18 provides the method of any one of Embodiments 1-17, wherein the resin in the first resin layer has a refractive index of about 1.500 to about 1.600.

Embodiment 19 provides the method of any one of Embodiments 1-18, wherein the resin in the first resin layer and the filler in the first resin layer have refractive indexes that are within about 0.080.

Embodiment 20 provides the method of any one of Embodiments 1-19, wherein the resin in the first resin layer and the filler in the first resin layer have refractive indexes that are within 0.030.

Embodiment 21 provides the method of any one of Embodiments 1-20, wherein the filler in the first resin layer is oriented in the extrusion direction of the first resin layer.

Embodiment 22 provides the method of any one of Embodiments 1-21, wherein about 50 wt % to about wt % of the filler in the first resin layer has a longest dimension oriented within about 45 degrees of the extrusion direction of the first resin layer.

Embodiment 23 provides the method of any one of Embodiments wherein about 90 wt % to about 100 wt % of the filler in the first resin layer has a longest dimension oriented within about 45 degrees of the extrusion direction of the first resin layer.

Embodiment 24 provides the method of any one of Embodiments 1-23, wherein the second layer is the same as the first resin layer.

Embodiment 25 provides the method of any one of Embodiments 1-24, wherein the second layer is different than the first resin layer.

Embodiment 26 provides the method of any one of Embodiments 1-25, wherein the second layer is an extruded layer.

Embodiment 27 provides the method of any one of Embodiments 1-26, wherein the second layer is an injection molded layer.

Embodiment 28 provides the method of any one of Embodiments 1-27, wherein in the layer stack the first layer is adjacent to the second layer.

Embodiment 29 provides the method of any one of Embodiments 1-28, wherein in the layer stack the first layer is separated from the second layer by one or more other layers.

Embodiment 30 provides the method of any one of Embodiments 1-29, wherein the layer stack comprises more than one first resin layer.

Embodiment 31 provides the method of any one of Embodiments 1-30, wherein the layer stack comprises more than one second resin layer.

Embodiment 32 provides the method of any one of Embodiments 1-31, wherein the second resin layer is free of filler.

Embodiment 33 provides the method of any one of Embodiments 1-32, wherein the second resin layer has a thickness of about 1 micron to about 100 mm.

Embodiment 34 provides the method of any one of Embodiments 1-33, wherein the second resin layer has a thickness of about 10 microns to about 10 mm,

Embodiment 35 provides the method of any one of Embodiments 1-34, wherein the resin in the second resin layer is comprises an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer CP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene diethylene terephthalate polymer (PCT), a poly(cyclohexylenedimethylene terephthalate-co-ethylene glycol) (PCTG), a Tritan™ copolyester, a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PIT), a polyurethane polymer (PU), a polyvinyl acetate polymer (PVA), a polyvinyl chloride polymer (PVC), a polyvinylidene chloride polymer (PVDC), a polyamideimide polymer (PAI), a polyaryl ate polymer, a polyoxymethylene polymer (POM), a styrene-acrylonitrile polymer (SAN), or a combination thereof.

Embodiment 36 provides the method of any one of Embodiments 1-35, wherein the resin in the second resin layer has a refractive index of 1.450 to about 1.800.

Embodiment 37 provides the method of any one of Embodiments 1-36, wherein the resin in the second resin layer has a refractive index of 1.500 to about 1.600.

Embodiment 38 provides the method of any one of Embodiments 1-37, wherein the filler-reinforced solid resin multilayered structure has a transmittance at 380-780 nm at 2.25 mm thickness of about 60% to about 95%.

Embodiment 39 provides the method of any one of Embodiments 1-38, wherein the filler-reinforced solid resin multilayered structure has a transmittance at 380-780 nm at 2.25 mm thickness of about 80% to about 90%.

Embodiment 40 provides the method of any one of Embodiments 1-39, wherein the filler-reinforced solid resin multilayered structure has a haze at 380-780 nm at 2.25 mm thickness of about 0.2% to about 20%.

Embodiment 41 provides the method of any one of Embodiments 1-40, wherein the filler-reinforced solid resin multilayered structure has a haze at 380-780 nm at 2.25 mm thickness of about 1% to about 10%.

Embodiment 42 provides the method of any one of Embodiments 1-41, wherein the filler-reinforced solid resin multilayered structure has a hardness of about 2B to about 9H.

Embodiment 43 provides the method of any one of Embodiments 1-42, wherein the filler-reinforced solid resin multilayered structure has a hardness of about F to about 3H.

Embodiment 44 provides the method of any one of Embodiments 1-43, further comprising heating the layer stack before the compressing of the layer stack, during the compressing of the layer stack, after the compressing of the layer stack, or a combination thereof.

Embodiment 45 provides the method of any one of Embodiments 1-44, further comprising cooling the layer stack during the compressing of the layer stack, after the compressing of the layer stack, or a combination thereof.

Embodiment 46 provides the method of any one of Embodiments 1-45, wherein the compression tool comprises a press or a roller.

Embodiment 47 provides the method of any one of Embodiments 1-46, further comprising preheating the compression tool prior to the compressing of the layer stack.

Embodiment 48 provides the method of Embodiment 47, wherein the preheating comprises preheating to equal to or greater than a melting point or glass transition temperature of the resin in each of the layers in the layer stack.

Embodiment 49 provides the method of any one of Embodiments 1-48, further comprising curing the resin in the first and second layers to form the filler-reinforced solid resin multilayered structure.

Embodiment 50 provides the method of Embodiment 49, wherein the curing occurs during the compressing.

Embodiment 51 provides the method of any one of Embodiments 1-50, further comprising cooling the compression tool during or after the compressing and before removing the filler-reinforced solid resin multilayered structure from the compression tool.

Embodiment 52 provides the method of any one of Embodiments 1-51, further comprising extruding the first resin layer.

Embodiment 53 provides the method of any one of Embodiments 1-52, wherein the portions of the compression tool that contact the layer stack have a roughness equal to or smoother than B3 in USA SPI standard,

Embodiment 54 provides the method of any one of Embodiments 1-53, wherein the portions of the compression tool that contact the layer stack have a roughness equal to or smoother than A3 in USA SPI standard.

Embodiment 55 provides the method of any one of Embodiments 1-54, wherein the layer stack comprises

layer (a1), the first resin layer; and

layer (b1), the second resin layer, wherein layer (a1) is fully in contact with layer (b).

Embodiment 56 provides the method of Embodiment 55, wherein the layer stack further comprises layer (a2), another first resin layer that is the same or different than layer (a1), wherein layer (a2) is fully in contact with layer (b1).

Embodiment 57 provides the method of any one of Embodiments 55-56, wherein the layer stack further comprises layer (b2), another second resin layer that is the same or different than layer (b2), wherein layer (b2) is fully in contact with layer (a1).

Embodiment 58 provides a method of forming a glass fiber-reinforced solid resin multilayered structure, the method comprising:

forming a layer stack comprising at least two monoextruded glass fiber-reinforced thermoplastic resin layers, the monoextruded layers each independently having a thickness of about 1 micron to about 500 microns, the monoextruded layers independently comprising a thermoplastic resin and glass fibers wherein a refractive index of the thermoplastic resin and a refractive index of the glass fibers in each layer are within about 0.100 of one another;

contacting the layer stack and a compression tool that is preheated above a glass transition temperature of the thermoplastic resin in each of the monoextruded layers; and

compressing the layer stack with the compression tool, to laminate he layers of the layer stack and form the glass fiber-reinforced solid resin multilayered structure.

Embodiment 59provides a method of forming a filler-reinforced solid resin multilayered structure, the method comprising:

forming a layer stack comprising a first resin layer that is a monoextruded filler-reinforced resin layer and one or more second resin layers that are the same as or different than the first resin layer, the monoextruded filler-reinforced resin layer comprising a filler and a resin and having a thickness of about 1 micron to about 500 microns;

preheating a compression tool;

contacting the layer stack and a compression tool, wherein the portions of the compression tool that contact the layer stack have a roughness equal to or smoother than B3 in USA SPI standard;

compressing the layer stack with the compression tool, to laminate the layers of the layer stack and form the filler-reinforced solid resin multilayered structure;

cooling the compression tool; and

removing the filler-reinforced solid resin multilayered structure from the compression tool,

Embodiment 60 provides a filler-reinforced solid resin multilayered structure, the structure comprising:

a laminated layer stack comprising a cured product of a first resin layer that is a monoextruded filler-reinforced resin layer and a cured product of one or more second resin layers that are the same as or different than the first resin layer, the monoextruded filler-reinforced resin layer comprising a filler and a resin and having a thickness of about 1 micron to less than about 1 mm, wherein about 50 wt % to about 100 wt % of the filler in the first resin layer has a longest dimension oriented within about 45 degrees of the extrusion direction of the first resin layer.

Embodiment 61 provides the filler-reinforced solid resin multilayered structure of Embodiment 60, wherein the filler in the first resin layer is glass fibers.

Embodiment 62 provides the filler-reinforced solid resin multilayered structure of any one of Embodiments 60-61, wherein the resin in the first resin layer comprises an aromatic polycarbonate and poly(1,4-cyclohexylidene cyclohexane-1,4-dicarboxylate).

Embodiment 63 provides the filler-reinforced solid resin multilayered structure of any one of Embodiments 60-62, wherein the filler in the first resin layer is glass fibers, wherein the glass fibers and the cured product of the resin in the first resin layer have refractive indexes that are independently about 1.500 to about 1.600.

Embodiment 64 provides the filler-reinforced solid resin multilayered structure of any one of Embodiments 60-63, wherein the cured product of the second layer is the same as the cured product of the first layer, wherein the cured product of the second layer is in contact with the cured product of the first layer.

Embodiment 65 provides a glass fiber-reinforced solid resin multilayered structure, the structure comprising:

a laminated layer stack comprising a cured product of at least two monoextruded glass fiber-reinforced thermoplastic resin layers, the monoextruded layers each independently having a thickness of about 1 micron to about 500 microns, the monoextruded layers independently comprising a thermoplastic resin and glass fibers, wherein a refractive index of the thermoplastic resin and a refractive index of the glass fibers in each layer independently is about 1.500 to about 1.600, wherein about 50 wt % to about 100 wt % of the filler in each of the monoextruded glass fiber-reinforced thermoplastic resin layers has a longest dimension oriented within about 45 degrees of the extrusion direction of the respective resin layer.

Embodiment 66 provides the filler-reinforced solid resin multilayered structure or method of any one or any combination of Embodiments 1-65 optionally configured such that all elements or options recited are available to use or select from.

1. A method of forming a filler-reinforced solid resin multilayered structure, the method comprising:
forming a layer stack comprising a first resin layer that is a monoextruded filler-reinforced resin layer and one or more second resin layers that are the same as or different than the first resin layer, the monoextruded filler-reinforced resin layer comprising a filler and a resin and having a thickness of about 1 micron to less than about 1 mm, the second resin layer comprising a resin;
contacting the layer stack and a compression tool; and
compressing the layer stack with the compression tool, to laminate the layers of the layer stack and form the filler-reinforced solid resin multilayered structure.

2. (canceled)

3. The method of claim 1, wherein the filler in the first resin layer is about 0.001 wt % to about 50 wt % of the first resin layer.

4. The method of claim 1, wherein the filler in the first resin layer comprises carbon fibers, glass beads, glass flakes, glass fibers, or a combination thereof.

5. The method of claim 1, wherein the resin in the first resin layer is about 50 wt % to about 99.999 wt % of the first resin layer.

6. The method of claim 1, wherein the resin in the first resin layer and the filler in the first resin layer have refractive indexes that are within about 0.080.

7. The method of claim 1, wherein the second layer is the same as the first resin layer.

8. The method of claim 1, wherein the second resin layer has a thickness of about 1 micron to about 100 mm.

9. The method of claim 1, wherein the filler-reinforced solid resin multilayered structure has a transmittance at 380-780 nm at 2.25 mm thickness of about 60% to about 95%.

10. The method of claim 1, wherein the filler-reinforced solid resin multilayered structure has a haze at 380-780 nm at 2.25 mm thickness of about 0.2% to about 20%.

11. The method of claim 1, wherein the compression tool comprises a press or a roller.

12. The method of claim 1, wherein the portions of the compression tool that contact the layer stack have a roughness equal to or smoother than B3 in USA SPI standard.

13. The method of claim 1, wherein the layer stack comprises
layer (a1), the first resin layer; and
layer (b1), the second resin layer, wherein layer (a1) is fully in contact with layer (b).

14. A method of forming a filler-reinforced solid resin multilayered structure, the method comprising:
forming a layer stack comprising a first resin layer that is a monoextruded filler-reinforced resin layer and one or more second resin layers that are the same as or different than the first resin layer, the monoextruded filler-reinforced resin layer comprising a filler and a resin and having a thickness of about 1 micron to about 500 microns;
preheating a compression tool;
contacting the layer stack and a compression tool, wherein the portions of the compression tool that contact the layer stack have a roughness equal to or smoother than B3 in USA SPI standard;
compressing the layer stack with the compression tool, to laminate the layers of the layer stack and form the filler-reinforced solid resin multilayered structure;
cooling the compression tool; and
removing the filler-reinforced solid resin multilayered structure from the compression tool.

15. (canceled)
